(19) United States
(12) Patent Application Publication
(10) Pub. No.: US 2011/0102180 A1
(43) Pub. Date: May 5, 2011

(54) APPARATUS AND METHOD FOR ESTIMATING TAG LOCATION

(75) Inventors: Youngwoo Choi, Daejeon (KR); Seong Yun Cho, Daejeon (KR); Dong Yong Kwak, Daejeon (KR)

(73) Assignee: ELECTRONICS AND TELECOMMUNICATIONS RESEARCH INSTITUTE, Daejeon (KR)

(21) Appl. No.: 12/827,341

(22) Filed: Jun. 30, 2010

(30) Foreign Application Priority Data
Nov. 3, 2009 (KR) 10-2009-0105692

(51) Int. Cl. G08B 13/14

(52) U.S. Cl. 340/572.4

(57) ABSTRACT

A first tag that is located in a communication coverage area among a plurality of tags is selected as a base tag in order to estimate tag location in an apparatus for estimating tag location that communicates with a plurality of tags. A second tag whose location is estimated among the plurality of tags is searched. First distance information of the second tag is estimated by performing a ranging procedure of the second tag. The second distance information estimated between the first tag and the second tag is received from the first tag, and the location information of the second tag is estimated by using the first distance information and the second distance information.

### CROSS-REFERENCE TO RELATED APPLICATION

This application claims priority to and the benefit of Korean Patent Application No. 10-2009-0105692 filed in the Korean Intellectual Property Office on Nov. 3, 2009, the entire contents of which are incorporated herein by reference.

### BACKGROUND OF THE INVENTION

(a) Field of the Invention

The present invention relates to a method for estimating tag location. More particularly, the present invention relates to a method for estimating tag location based on impulse radio-ultra wide band (IR-UWB) communication.

(b) Description of the Related Art

Impulse radio-ultra wide band (hereinafter referred to as “IR-UWB”) communication uses a short pulse of several nanoseconds, and thus is applied to a high-precision location estimating system. Since the IR-UWB communication uses wideband of 500 MHz, tapping is almost impossible and power consumption is small, such that the IR-UWB communication is highly likely to be used for a portable terminal or a mobile device. Currently, the IR-UWB communication having the advantages tends to be used for a civil or military location estimating system.

Meanwhile, the civil or military location estimating system obtains its owns location information by using GPS (global positioning system), INS (inertial navigation system), LORAN (long range navigation), RFID (radio-frequency identification)/USN (ubiquitous sensor network), etc. When there are persons or objects that require location information, their own location information is provided by wireless or is provided by a location estimating scheme, such as a scheme used in radar, etc. When the location information is estimated in the battlefield using a GPS, if the GPS cannot be used or receives an incorrect signal, it is difficult to accurately estimate location, and since the GPS is vulnerable to security breaches, the location information of troops can be exposed to enemy troops.

In addition, when the GPS cannot be used, the location can be estimated by a wireless communication infrastructure. To this end, multiple wireless access devices (access points) that can accurately appreciate locations and can be references should be installed. However, it is difficult to install a base station in a battle location, and even when the installation of the base station is completed, the base station cannot be used when it is subjected to an external impact, such that it is difficult to estimate location.

Although the military location estimating system that can estimate the location of troops using the IR-UWB communication is considered, the currently developed IR-UWB communication has a limitation of transmission power by FCC (Federal Communications Commission) regulations and thus has a disadvantage in that radio coverage is not wide, such that it is not widely used as a system for estimating location of soldiers in the battlefield.

Therefore, a need exists for a secure technology for estimating tag location based on the IR-UWB communication in the civil location estimating system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for estimating tag location based on impulse radio-ultra wide band (IR-UWB) communication.

In order to achieve the above objects, a method for estimating tag location in an apparatus for estimating tag location that communicates with a plurality of tags according to an exemplary embodiment of the present invention includes:

selecting as a base tag a first tag that is located in a communication coverage area among the plurality of tags; searching a second tag whose location is estimated among the plurality of tags; estimating first distance information of the second tag by performing a ranging procedure with the second tag; receiving second distance information that is estimated between the first tag and the second tag from the first tag; and estimating the location information of the second tag by using the first distance information and the second distance information.

In addition, a method for estimating location of a tag adjacent to a first tag whose location is estimated in an apparatus for estimating tag location among a plurality of tags according to another embodiment of the present invention includes:

searching at least one adjacent tag that is located in the communication coverage area of the first tag; updating a first location information table by estimating distance information of at least one adjacent tag; updating the first location information table by estimating distance information of the apparatus for estimating tag location; receiving an updating time of a second location information table stored in the apparatus for estimating tag location from the apparatus for estimating tag location; comparing the updating time of the first location information table with the updating time of the second location information table; and transmitting the first location information table to the apparatus for estimating tag location or receiving the second location information table from the apparatus for estimating tag location.

### BRIEF DESCRIPTION OF THE DRAWINGS

FIG. 1 is a diagram schematically showing a system for estimating tag location according to an exemplary embodiment of the present invention;

FIG. 2 is a diagram schematically showing an apparatus for estimating tag location in the system for estimating tag location shown in FIG. 1;

FIG. 3 is a diagram showing one example of a location information table according to the exemplary embodiment of the present invention;

FIG. 4 is a diagram schematically showing tags of a system for estimating tag location shown in FIG. 1;

FIG. 5 is a diagram showing a sequence of providing a location information table by estimating the location information of tags in the apparatus for estimating tag location according to the exemplary embodiment of the present invention; and

FIG. 6 is a diagram showing a sequence of providing the location information table by estimating the location information of adjacent tags in tags according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

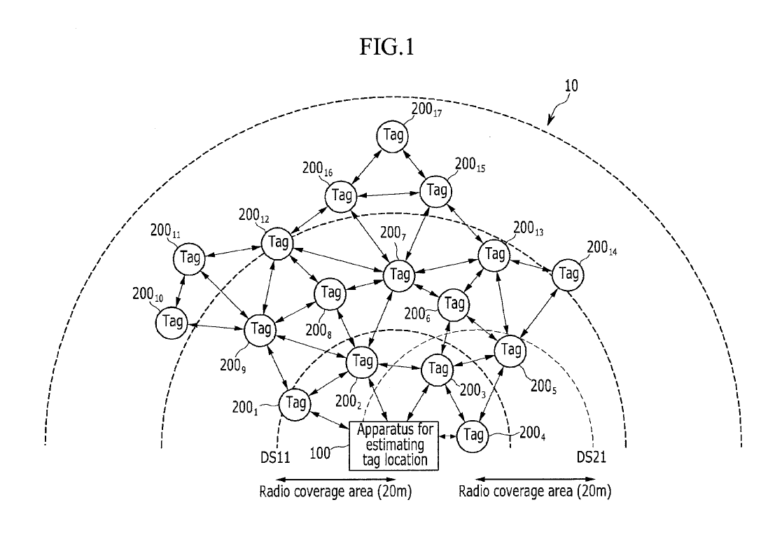

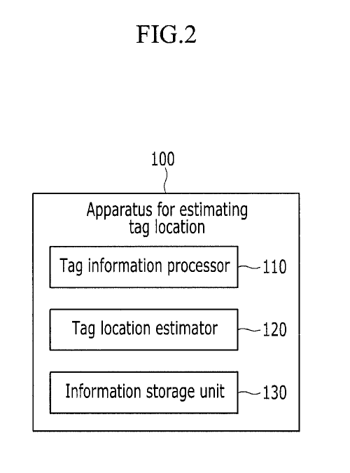

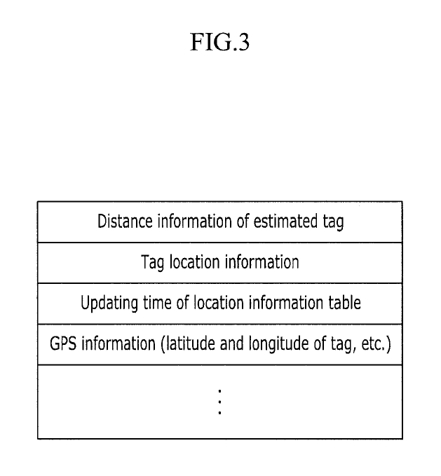

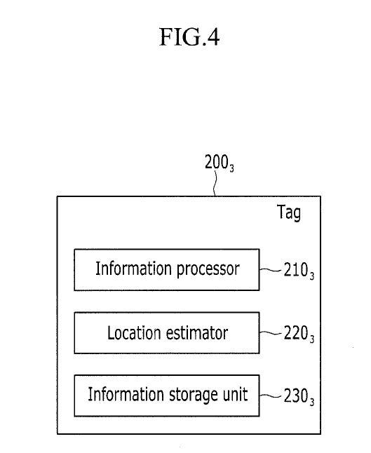

FIG. 1 is a diagram schematically showing a system for estimating tag location according to an exemplary embodiment of the present invention. FIG. 2 is a diagram schematically showing an apparatus for estimating tag location in the system for estimating tag location shown in FIG. 1, and FIG. 3 is a diagram showing one example of a location information table according to the exemplary embodiment of the present invention. FIG. 4 is a diagram schematically showing tags of a system for estimating tag location shown in FIG. 1.

As shown in FIG. 1, a system for estimating tag location 10 according to an exemplary embodiment of the present invention includes an apparatus for estimating tag location 100 and a plurality of tags 200₁-200₁₇. Although the number of tags 200₁-200₁₇ is limited to 17 in the exemplary embodiment of the present invention, the present invention is not limited thereto, and at least one tag may be included in the system for estimating tag location.

The apparatus for estimating tag location 100 generates a location information table by estimating location information of a tag of which the location is searched through communication with the plurality of tags 200₁-200₁₇ based on the IR-UWB communication.

Referring to FIGS. 1 and 2, the apparatus for estimating tag location 100 includes a tag information processor 110, a tag location estimator 120, and a tag information storage unit 130.

The tag information processor 110 receives identifiers for a plurality of tags 200₁-200₁₇ and stores them in the information storage unit 130. At this time, each tag 200₁-200₁₇, which is registered in the tag information processor 110, may be disposed at any location.

The tag location estimator 120 sets any tag that is located within its radio coverage area DS11 among the plurality of tags 200₁-200₁₇ as a base tag. The base tag is set as any tag in the radio coverage area by the tag location estimator 120 in order to estimate the location of a searched tag. In the exemplary embodiment of the present invention, a tag 200₄, which is located within the radio coverage area DS11, i.e., within a 20 m radius of the apparatus for estimating tag location 100, is set as a base tag.

The tag location estimator 120 searches tags in its own radio coverage area DS11 to estimate distance information thereof. In the exemplary embodiment of the present invention, it is assumed that the radio coverage area DS11 of the apparatus for estimating tag location 100 is set to 20 m, and that the location of a tag 200₃ of a plurality of tags 200₁-200₁₇ within that area is searched. At this time, the base tag 200₄ also searches tags in its own radio coverage area DS21 that has the same radius as that of the apparatus for estimating tag location 100, and estimates the distance information of the corresponding tags and transfers the distance information of the corresponding tags to the tag information processor 110. In the exemplary embodiment of the present invention, it is assumed that the radio coverage area DS21 of the base tag 200₄ is set to 20 m, and that the location of the tag 200₃ of the plurality of tags 200₁-200₁₇ is searched.

The tag location estimator 120 estimates the location information of the tag 200₃ through the distance information of the tag 200₃ that is estimated by the tag location estimator 120 and the distance information of the tag 200₃ that is estimated by the base tag 200₄. The tag location estimator 120 stores the distance information of the tag 200₃ that is estimated by the tag location estimator 120, the distance information of the tag 200₃ that is estimated by the base tag 200₄, the location information of the tag 200₃, the time of updating the location information table (hereinafter referred to as “table updating time”), the GPS information, etc., to generate the location information table, and one example of the location information table is shown in FIG. 3.

The tag location estimator 120 receives a table updating time stored in the location information table of the tag 200₃ from the tag 200₃, and updates the storage contents of the location information table to contents of more recently updated location information data according to results of comparing its own table updating time with a table updating time received from the tag 200₃.

The tag information storage unit 130 receives and stores the identifiers for the plurality of tags 200₁-200₁₇ from the tag information processor 110. The tag information storage unit 130 stores the location information table that is generated and updated in the tag location estimator 120.

Referring back to FIG. 1, each of the plurality of tags 200₁-200₁₇ may be included in a respective terminal (not shown), and performs communication with the apparatus for estimating tag location 100 to update the location information table according to the results of comparing the table updating time. In addition, the distances of the adjacent tags (hereinafter referred to as “adjacent tags”) of the plurality of tags 200₁-200₁₇ are estimated through a ranging procedure based on the IR-UWB communication, similar to that of the apparatus for estimating tag location 100.

In other words, each of the plurality of tags 200₁-200₁₇ performs communication with adjacent tags in their own radio coverage areas to generate, update, and store their own location information table. The configuration and function of the plurality of tags 200₁-200₁₇ according to the exemplary embodiment of the present invention are the same, and therefore the configuration and function of only the tag 200₃ will be described.

In detail, referring to FIG. 4, the tag 200₃ according to the exemplary embodiment of the present invention includes an information processor 210₃, a location estimator 220₃, and an information storage unit 230₃.

The information processor 210₃ transmits an identifier of its own to the apparatus for estimating tag location 100 and requests registration thereof.

The location estimator 220₃ searches adjacent tags in its own radio coverage area. In other words, since the location estimator 220₃ cannot estimate its location by allowing the apparatus for estimating tag location 100 to perform direct communication with a tag that is located outside its radio coverage area DS11, it estimates the distance information to its own adjacent tags 200₅ and 200₆ that are located outside the radio coverage area DS11 and receives the GPS information and transmits it to the apparatus for estimating tag location 100. Similarly, the location estimators 220₁, 220₂, and 220₄-220₁₇ of the plurality of remaining tags 200₁, 200₂, and 200₄-200₁₇ also estimate the distance information to the tags adjacent thereto, and receive the GPS information to update their own location information tables. Each location estimator 220₃ stores their location information table in their information storage unit 230₃.

Meanwhile, the location estimator 220₃ performs the ranging procedure with the apparatus for estimating tag location 100. The location estimator 220₃ receives the table updating time in the apparatus for estimating tag location 100, and compares the updating time in its own table with the table updating time received from the apparatus for estimating tag location 100. The location estimator 220₃ updates the stored information to contents of more recently updated location information table according to the results of comparing the table updating times.

The information storage unit 230₁ stores the location information table that is generated and updated in the location estimator 220₃.

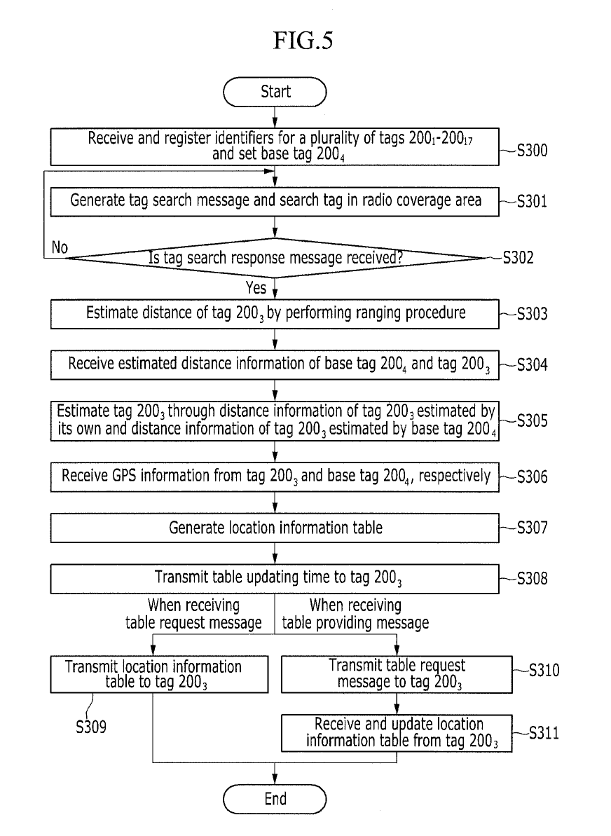

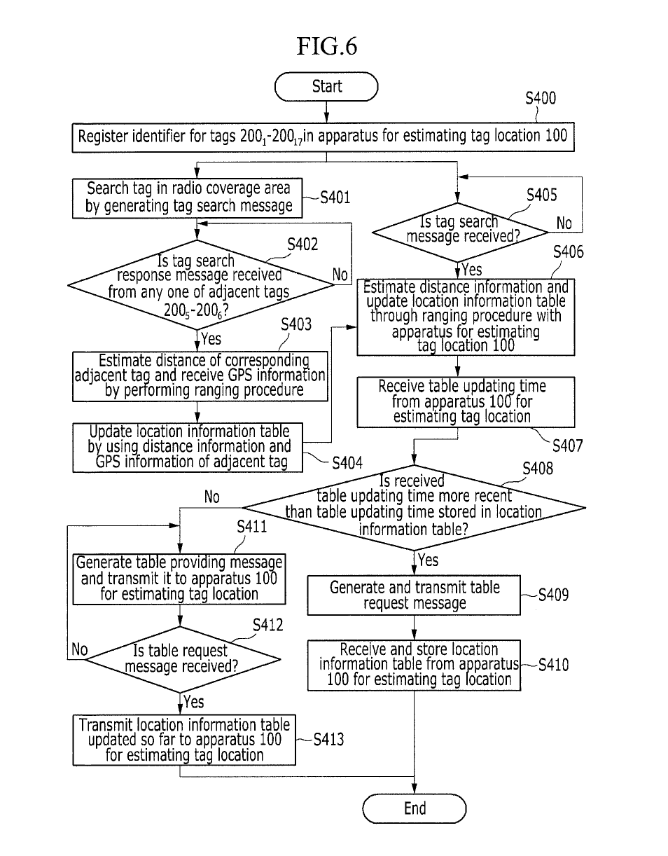

Hereinafter, referring to FIGS. 5 and 6, the method of estimating the location information of tags according to the exemplary embodiment of the present invention will be described in detail.

FIG. 5 is a diagram showing a sequence of providing the location information table by estimating the location information of tags in the apparatus for estimating tag location according to the exemplary embodiment of the present invention.

Referring to FIG. 5, the tag information processor 110 in the apparatus for estimating tag location 100 according to the exemplary embodiment of the present invention receives identifiers for the plurality of tags 200₁-200₁₇ to register each tag 200₁-200₁₇. The tag location estimator 120 in the apparatus for estimating tag location 100 selects any tag that is located in its radio coverage area DS11 among the plurality of tags 200₁-200₁₇ as a base tag (S300), and in this case, the tag 200₄ is chosen as the base tag.

The tag location estimator 120 generates a tag search message and transmits the generated tag search message to search the tags in its own radio coverage area DS11 (S301). In the exemplary embodiment of the present invention, it is assumed that the location of the tag 200₃ of the plurality of tags 200₁-200₁₇ is searched. The tag location estimator 120 determines whether a tag search response message is received from the searched tag 200₃ as a response to the tag search message (S302).

When the tag search response message is received, the tag location estimator 120 performs the ranging procedure to estimate the distance information of the tag 200₃ (S303).

At this time, the base tag 200₄ also generates a tag search message, similar to the apparatus for estimating tag location 100, and transmits the generated tag search message to search the tags in its own radio coverage area DS21. In the exemplary embodiment of the present invention, it is assumed that the radio coverage area DS21 of the base tag 200₄ is set to 20 m, and that the location of the tag 200₃ of the plurality of tags 200₁-200₁₇ is searched. The base tag 200₄ receives the tag search response message from the tag 200₃ and performs the ranging procedure to estimate the distance information of the tag 200₃. The base tag 200₄ transmits the estimated distance information of the tag 200₃ to the tag information processor 110. The tag location estimator 120 receives the estimated distance information between the base tag 200₄ and the tag 200₃ that is transmitted to the tag information processor 110 (S304).

The tag location estimator 120 generates a circle whose radius is the estimated distance information of the tag 200₃. The tag location estimator 120 also generates a circle whose radius is the estimated distance information between the base tag 200₄ and the tag 200₃. The tag location estimator 120 estimates the location of the tag 200₃ to be at a point where the circle whose radius is the estimated distance information of the tag 200₃ intersects the circle whose radius is the estimated distance information between the base tag 200₄ and the tag 200₃. In other words, the tag location estimator 120 estimates the location information of the tag 200₃ by using the distance information of the tag 200₃ estimated by the tag location estimator 120 and the distance information of the tag 200₃ estimated by the base tag 200₄ (S305).

The tag location estimator 120 receives the GPS information from the tag 200₃ and the GPS information from the base tag 200₄ (S306). The GPS information may include location-related information, such as latitude, longitude, etc. The tag location estimator 120 uses the GPS information of the tag 200₃ to estimate the absolute location of the tag 200₃. The absolute location may be represented by location coordinates that are generated by using, for example, the latitude and longitude of the tag 200₃. The tag location estimator 120 uses its own GPS information and the GPS information of the base tag 200₄ to estimate a relative location. The relative location is the location information of the tag 200₃ that is relatively estimated from the apparatus for estimating tag location 100 by using each set of GPS information.

The absolute location and relative location, which are estimated by using the GPS information according to the exemplary embodiment of the present invention, are auxiliary units that reduce the error of the location information estimated by performing the ranging procedure and the tag location estimator 120 in the apparatus for estimating tag location 100 according to the exemplary embodiment of the present invention, and may estimate the accurate location information of the tag by using only the distance information that is estimated according to the ranging procedure without using the GPS information.

The tag location estimator 120 performs the ranging procedure to generate the location information table that includes the estimated distance information, the location information of the tag 200₃, the table updating time, the GPS information, etc. (S307). The tag location estimator 120 transmits the table updating time stored in the location information table to the tag 200₃ (S308).

At this time, the tag 200₃ compares the table updating time received from the apparatus for estimating tag location 100 and the table updating time that is already stored in the tag 200₃.

As a comparison result, when the table updating time received from the location estimating apparatus 100 is more recent information, the tag 200₃ generates a table request message that requests the location information table and transmits it to the apparatus for estimating tag location 100. The tag location estimator 120 in the apparatus for estimating tag location 100 receives the table request message from the tag 200₃. The tag location estimator 120, according to the table request message received from the tag 200₃, transmits its own location information table to the tag 200₃ (S309).

According to the comparison result, when the already stored table updating time is more recent, the tag 200₃ generates the table providing message for providing a location information table and transmits it to the apparatus for estimating tag location 100. The tag location estimator 120 in the apparatus for estimating tag location 100 generates the table request message in response to the table providing message and transmits it to the tag 200₃ (S310). The tag 200₃ transmits its own location information table to the apparatus for estimating tag location 100 in response to the table request message. The apparatus for estimating tag location 100 receives the location information table transmitted from the tag 200₃ and updates its own location information table (S311).

FIG. 6 is a diagram showing a sequence of providing the location information table by estimating the location of adjacent tags in tags according to the exemplary embodiment of the present invention.

Referring to FIG. 6, the plurality of tags 200₁-200₁₇ according to the exemplary embodiment of the present invention register their own identifiers to the tag location estimating apparatus 100 (S400). At this time, the registered tags 200₁-200₁₇ are disposed at any location. In the exemplary embodiment of the present invention, it is assumed that the tag 200₃ of the plurality of tags 200₁-200₁₇ provides the location information table to the apparatus for estimating tag location 100.

The tag 200₃ generates a tag search message and transmits the tag search message to the adjacent tags in its own radio coverage area DS21 to search the adjacent tags 200₅ and 200₆ (S401). The tag 200₃ determines whether a tag response message as a response to the tag search message is received from the adjacent tags 200₅ and 200₆ (S402).

First, when the tag search response message is received from the adjacent tag 200₅, the tag 200₃ and the adjacent tag 200₅ perform the ranging procedure to estimate the distance information of the adjacent tag 200₅. The tag 200₃ receives the GPS information from the adjacent tag 200₅ (S403). The tag 200₃ updates the location information table of the tag 200₃ based on the received GPS information and the distance information that is estimated by performing the ranging procedure with the tag 200₅ (S404).

By the same method, the tag 200₃ estimates the distance information by performing the ranging procedure with the remaining adjacent tag 200₆ and updates the location information table based on GPS information received from the tag 200₆ and the estimated distance information of the tag 200₆.

Meanwhile, the tag 200₃ determines whether the tag search message is received from the apparatus for estimating tag location 100 (S405). When the tag search message is received from the apparatus for estimating tag location 100, the tag 200₃ performs the ranging procedure with the apparatus for estimating tag location 100 to estimate the distance information of the apparatus for estimating tag location 100. The tag 200₃ updates the location information table that includes the distance information of the so-far estimated adjacent tags 200₅ and 200₆ and the GPS information of each adjacent tag 200₅ and 200₆ by storing the distance information of the apparatus for estimating tag location 100 in the location information table (S406).

The tag 200₃ receives the table updating time from the apparatus for estimating tag location 100 (S407). The tag 200₃ compares the table updating time stored in its own location information table with the table updating time received from the apparatus for estimating tag location 100. In other words, the tag 200₃ determines whether the received updating time is more recent information than the table updating time stored in its own location information table (S408).

When the received table updating time is more recent information than the table updating time stored in its own information table, the tag 200₃ generates a table request message that requests the location information table and transmits it to the apparatus for estimating tag location 100 (S409). The tag 200₃ receives and stores the location information table from the apparatus for estimating tag location 100 as a response to the table request message (S410). In other words, the tag 200₃ updates its own location information table with the location information table received from the contents of the apparatus for estimating tag location 100.

Meanwhile, when the table updating time stored in the location information table of the tag 200₃ is more recent information than the received table updating time, the tag 200₃ generates a table providing message for providing its own location information table and transmits it to the apparatus for estimating tag location 100 (S411). The tag 200₃ determines whether the table request message requesting the location information table is received in response to the table providing message from the apparatus for estimating tag location 100 (S412).

When the table request message is received from the apparatus for estimating tag location 100, the tag 200₃ transmits its own location information table, which is updated so far, to the apparatus for estimating tag location 100 (S413).

As described above, the apparatus for estimating tag location 100 according to the exemplary embodiment of the present invention estimates a location of a tag located in the radio coverage area by using any predetermined tag established as a base tag.

In addition, the apparatus estimates the location of a tag that is located outside of the radio coverage area by using the distance information of adjacent tags received from the plurality of tags 200₁-200₁₇ provided by estimating the distance information of the tag adjacent thereto, based on the IR-UWB communication, similar to the apparatus for estimating tag location 100, such that it can estimate the location of all tags that are located inside and outside the radio coverage area without installing a wireless access apparatus that is a reference point, thereby making it possible to estimate the location of a tag even in an environment where the installation of the wireless access apparatus is not easy.

Accordingly, the exemplary embodiment of the present invention can estimate the location of tags inside and outside a communication coverage area of a location estimating apparatus by using an IR-UWB communication scheme of a low-rate wireless personal area network (LR-WPAN).

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for estimating tag location in an apparatus for estimating tag location that communicates with a plurality of tags, comprising:
selecting as a base tag a first tag that is located in a communication coverage area among the plurality of tags;
searching a second tag whose location is estimated among the plurality of tags;
estimating first distance information of the second tag by performing a ranging procedure with the second tag;
receiving second distance information that is estimated between the first tag and the second tag from the first tag; and
estimating location information of the second tag by using the first distance information and the second distance information.

2. The method for estimating tag location of claim 1, wherein
the estimating the location information of the second tag includes:
generating a circle whose radius is the first distance information;
generating a circle whose radius is the second distance information; and
estimating a point where the circle whose radius is the first distance information intersects the circle whose radius is the second distance information to be the location information of the second tag.

3. The method for estimating tag location of claim 2, wherein
the estimating the location information of the second tag includes:
receiving the GPS information of the second tag from the second tag; and
estimating the absolute location of the second tag by using the GPS information of the second tag.

4. The method for estimating tag location of claim 2, wherein
the estimating the location information of the second tag includes:
receiving the GPS information of the first tag from the first tag; and
estimating a relative location of the second tag from the apparatus for estimating tag location by using the GPS information of the first tag and the GPS information of the apparatus for estimating tag location.

5. The method for estimating tag location of claim 3, wherein
the estimating the location information of the second tag includes
generating a location information table including the location information of the second tag.

6. The method for estimating tag location of claim 5, wherein
the location information table further includes
the first distance information, the second distance information, the updating time of the location information table, the GPS information of the first tag, and the GPS information of the second tag.

7. A method for estimating location of a tag adjacent to a first tag whose location is estimated in an apparatus for estimating tag location among a plurality of tags, comprising:
searching at least one adjacent tag that is located in a communication coverage area of the first tag;
updating a first location information table by estimating distance information of at least one adjacent tag;
updating the first location information table by estimating distance information of the apparatus for estimating tag location;
receiving an updating time of a second location information table stored in the apparatus for estimating tag location from the apparatus for estimating tag location;
comparing updating time of the first location information table with the updating time of the second location information table; and
transmitting the first location information table to the apparatus for estimating tag location or receiving the second location information table from the apparatus for estimating tag location.

8. The method for estimating tag location of claim 7, further comprising:
receiving GPS information of at least one adjacent tag; and
storing the GPS information of at least one adjacent tag and the GPS information of the first tag to update the first location information table.

9. The method for estimating tag location of claim 7, wherein
the receiving the second location information table includes:
when the updating time of the second location information table is more recent than the updating time of the first location information table, receiving the second location information table from the apparatus for estimating tag location; and
updating the contents of the first location information table with the contents of the second location information table.

10. The method for estimating tag location of claim 7, wherein
the receiving the second location information table includes,
when the updating time of the first location information table is more recent than the updating time of the second location information table, transmitting the first location information table to the apparatus for estimating tag location.
